(19) United States
(12) Patent Application Publication
(10) Pub. No.: US 2023/0373603 A1
(43) Pub. Date: Nov. 23, 2023

(54) DEVICE FOR COLLECTING MARINE SEDIMENTS USING A REMOTELY OPERATED VEHICLE

(71) Applicant: PETRÓLEO BRASILEIRO S.A., Rio de Janeiro (BR)

(72) Inventor: DENNIS JAMES MILLER, Rio de Janeiro (BR)

(21) Appl. No.: 18/308,978

(22) Filed: Apr. 28, 2023

(30) Foreign Application Priority Data
Apr. 29, 2022 (BR) 10 2022 008334 7

(51) Int. Cl. B63G 8/00; G01N 1/08

(52) U.S. Cl. CPC B63G 8/001; G01N 1/08; B63G 2008/005

(57) ABSTRACT

The present invention relates to a device for collecting marine sediments using a remotely operated vehicle (ROV), comprising at least one handle, at least one central body, at least one drive mechanism, and at least one cover, in which at least one central body includes a lower end comprising an opening, wherein the drive mechanism comprises at least one joining means for connection to a drive system of the ROV, and wherein the at least one cover comprises at least one hingeable structure including at least one connection means with at least one drive mechanism.

### FIELD

The present invention relates to the technical field of subsea operations and, specifically, to a device for collecting marine sediments using a remotely operated vehicle (ROV, Remotely Operated Vehicle).

### BACKGROUND

The geochemical analysis of marine sediment samples occupies an important position in the monitoring of hydrocarbon leakage on the ocean floor.

In this sense, the geochemical analysis carried out based on samples of marine sediments aims at ensuring the environmental safety of oil exploration and production activities.

Additionally, with the objective of subsidizing exploratory activities, the collection and geochemical analysis of these sediments in exudation sites also play a notable role in the field in question.

Finally, the operation of collecting marine sediments on the ocean floor stands out for having variables that can directly influence the quantitative and qualitative evaluation of these samples.

Conventionally, the collection of marine sediments in the vicinity of subsea facilities is carried out with equipment that has structural deficiencies in retaining consolidated or poorly consolidated samples. Specifically, because of these shortcomings, collected marine sediment samples may be lost along the up path from the ocean floor to the support vessel.

Losses of collected marine sediment samples result in losses related to productivity, time, and operating costs. Furthermore, due to losses, the geochemical analysis may not be performed considering a complete spectrum of marine sediment samples, which reflect the reality of the ocean floor that one wishes to analyze.

In a complementary way, the preponderant factors in the marine sediment collection operation and subsequent geochemical analysis thereof are the determination of the location for carrying out said collection and the correct positioning of the collector in a suitable point for the recovery of a desired marine sediment material.

Therefore, there is a need for a device to collect marine sediments, so that consolidated or poorly consolidated samples are not lost along the up path from the ocean floor to the support vessel. Additionally, there is a need for a device to collect marine sediments that is positioned in an appropriate location.

### STATE OF THE ART

In the state of the art, there are devices designated for the collection of marine sediments on the ocean floor. However, the existing devices have problems related to the retention of poorly consolidated marine sediments, along the path to the support vessel.

The patent document U.S. Pat. No. 8,908,476B2 discloses a sediment collector device from the ocean floor, in which the collector device is coupled to an ROV. The collector described includes left and right buckets, a mover that can move up and down with respect to an ROV cable, a hook rotatably connected to the vertical mover and supported on a pin. Specifically, the pin is used to assist in the relative up and down movement of the mover relative to the ROV cable. The left and right buckets are open for spiking said device into the ocean floor. After spiking the collector into the ocean floor, the ROV moves the mover upwards, causing the buckets to rotate until the space between them is completely closed and the sediments are stored inside the same.

In turn, document US2020325745A1 describes a device to collect sediments from the ocean floor, which comprises an ROV that supplies electrical and hydraulic energy to a collector robot that collects said sediments. The collector robot includes a rotating tube that excavates the ocean floor, and is fed with the sediments obtained from the excavation. In addition, the rotating tube breaks the sediment into smaller pieces, which are transferred from the tube to the ROV via a suction hose.

Document CN107907361A defines, in turn, a submerged sediment sampling device, which acts autonomously, comprising a plurality of electrical, hydraulic and mechanical components, such as: a pressure-resistant chamber with controller and power supply, pump, hydraulic cylinder, valves, piston and collection cylinder.

As can be seen from the description of the documents of the State of the Art indicated above, there are devices for collecting marine sediments from the ocean floor that operate autonomously or are coupled to an ROV, comprising buckets that close along the up path to the marine surface and suction hoses for sediment.

Although there are documents in the State of the Art that describe devices for collecting marine sediments, these lack structures related to the retention of consolidated or poorly consolidated samples, before starting the up path, between the ocean floor and the support vessel. Additionally, the existing devices do not apply the use of ROV in order to guarantee an adequate positioning of the collection device based on the marine sediments that one wishes to collect.

Therefore, a device is needed to collect marine sediments, so that samples are not lost along the path. Additionally, there is a need for a device to perform the sampling of marine sediments that is positioned in a suitable place to carry out the desired collection.

### BRIEF DESCRIPTION

The present invention defines, according to a preferred embodiment, a device for collecting marine sediments using a remotely operated vehicle (ROV), comprising at least one handle, at least one central body, at least one drive mechanism, and at least one cover, wherein the at least one central body includes a lower end comprising an opening, wherein the drive mechanism comprises at least one joining means for connection to a drive system of the ROV, and wherein at least one a cover comprises at least one hingeable structure including at least one connection means with at least one drive mechanism.

### BRIEF DESCRIPTION OF FIGURES

In order to complement the present description and to obtain a better understanding of the features of the present invention, there is presented attached a set of figures, where in an exemplified way, although not limiting, its preferred embodiment is represented.

FIG. 1 represents the device for collecting marine sediments using a remotely operated vehicle (ROV), according to a preferred embodiment of the present invention.

FIG. 2 illustrates a sectional view of the device for collecting marine sediments using a remotely operated vehicle (ROV), according to a preferred embodiment of the present invention, with the cover closing the lower opening of the central body.

### DETAILED DESCRIPTION

The device for collecting marine sediments using a remotely operated vehicle (ROV), according to a preferred embodiment of the present invention, is described in detail based on the attached figures.

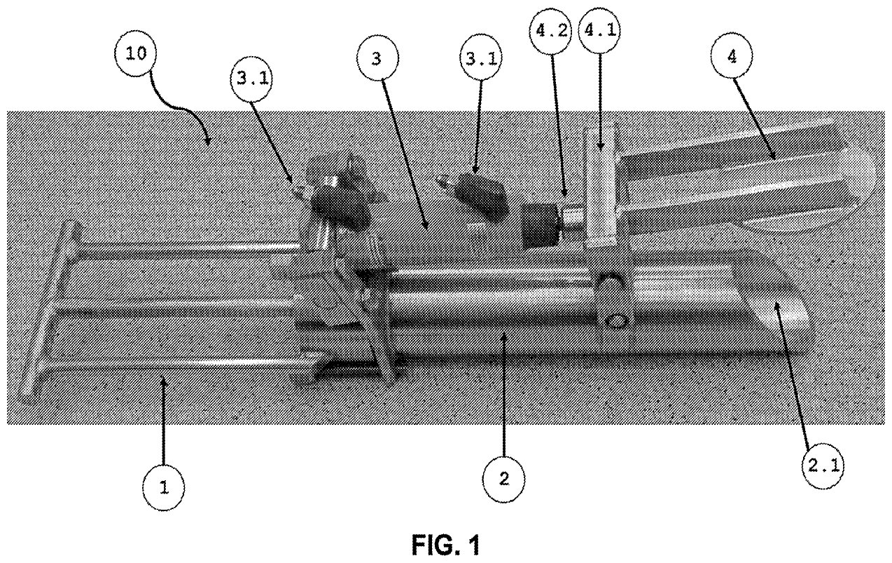

According to FIG. 1, the device for collecting marine sediments using a remotely operated vehicle (ROV) 10 comprises at least one handle 1, at least one central body 2, at least one drive mechanism 3, and at least one cover 4.

With respect to the handle 1, this is attached to the upper part of the central body 2, wherein this attachment can be carried out through any suitable means of attachment; such as, for example, screw, screw with nut and washer, or welding. The handle 1 can be manufactured from any material that can be applied to the marine environment, such as stainless steel or stainless-steel alloys.

Additionally, the handle 1 is configured to allow the device for collecting marine sediments using a remotely operated vehicle (ROV) 10 can be transported, for example, by an operator. In addition, the handle 1 allows the connection of cables, moorings or chains to carry out the submersion of the device for collecting marine sediments using a remotely operated vehicle (ROV) 10 from the sea surface to the ocean floor, as well as in the up moving of the same from the ocean floor to the support vessel.

As seen in the preferred embodiment of FIG. 1, the handle 1 may have a “T” shape and, preferably, comprise one or more vertical rods attached to the central body 2.

With respect to the central body 2, this comprises an internal space for storing marine sediments and can be manufactured from any material that can be applied to the marine environment, such as stainless steel or stainless-steel alloys.

At least one central body 2, as the preferred embodiment of the present invention illustrates in FIG. 1, may have a tubular shape, for example, where the central body 2 is at least a tube, for example.

In this sense, according to the embodiment of FIG. 1, the central body 2 is formed by a tube, wherein the tube is a partially or completely hollow tube, which allows an internal space therein for the storage of marine sediments. Additionally, the central body 2 can have any shape, such as a tubular, parallelepiped, or cylindrical shape, for example.

Furthermore, the central body 2 includes a lower end comprising an opening 2.1. The opening 2.1 at the lower end of the central body 2 has the function of allowing marine sediments to enter the interior of the central body 2.

According to a preferred embodiment of the present invention, the opening 2.1 at the lower end of the central body 2 is a chamfered opening 2.1. More specifically, the chamfered opening 2.1 at the lower end of the central body 2 serves to carry out the spiking of the device for collecting marine sediments using a remotely operated vehicle (ROV) 10 on the ocean floor.

FIG. 1 additionally presents at least one drive mechanism 3, where at least one drive mechanism 3 is attached to the central body 2. More preferably, the drive mechanism 3 is attached to the central body 2 with a structure suitable for the type of drive mechanism and providing a secure attachment thereof to the central body 2. According to another preferred way, at least one drive mechanism 3 is attached to the upper part of the central body 2.

Furthermore, at least one drive mechanism 3 is at least one hydraulic cylinder or at least one pneumatic cylinder, for example.

The drive mechanism 3 comprises at least one joining means 3.1 for connecting to a drive system of the ROV, wherein, preferably, the drive system of the ROV is a hydraulic system or a pneumatic system. The joining means 3.1 can be any joining means that interconnects the drive mechanism 3 with a compatible ROV drive system, such as, for example, an elbow.

In turn, at least one cover 4 is arranged at the bottom of the device for collecting marine sediments using a remotely operated vehicle (ROV) 10. Specifically, the cover 4 is attached to the central body 2, and, preferably, the cover 4 is attached to the central body 2 through at least one hingeable structure 4.1.

More preferably, the cover 4 is attached to the lower end of the central body 2 through at least one hingeable structure 4.1. More specifically, the cover 4 is attached to the lower part of the central body 2 through at least one hingeable structure 4.1, so that the cover is parallel to the central body 2.

At least one hingeable structure 4.1 of the cover 4 comprises at least one connection means 4.2 for connection with the drive mechanism 3.

Specifically, the cover 4 is configured to be movable between a position parallel to the central body 2 and a closing position of the opening 2.1 of the lower end of the central body 2, wherein the movement takes place through the driving performed by at least one drive mechanism 3, wherein the at least one drive mechanism 3 is connected to at least one connection means 4.2 of the hingeable structure 4.1 of the cover 4 and to the drive system of the ROV 3.2, through the at least one joining means 3.1.

More specifically, the closing of the opening 2.1 at the lower end of the central body 2 by the cover 4 is carried out immediately after spiking the device for collecting marine sediments using a remotely operated vehicle (ROV) 10 on the ocean floor.

Thus, immediately after spiking said device 10 of the present invention on the ocean floor, the cover 4 is driven through at least one drive mechanism 3, wherein at least one drive mechanism 3 is connected to a drive system of the ROV and to the connection means 4.2 of the hingeable structure 4.1 of the cover 4, thus driving the cover 4 into the closing position of the chamfered opening 2.1 at the lower end of the central body 2. The drive mechanism 3 is at least one hydraulic cylinder or at least one pneumatic cylinder. The drive mechanism 3 comprises at least one joining means 3.1 for connection with a drive system of the ROV. preferably, a system compatible with the drive mechanism 3; in this case, a hydraulic system or a pneumatic system, according to the preferred embodiment of the present invention.

The cover 4 and the hingeable structure 4.1 can be manufactured from any material that can be applied to the marine environment; for example, stainless steel or stainless-steel alloys.

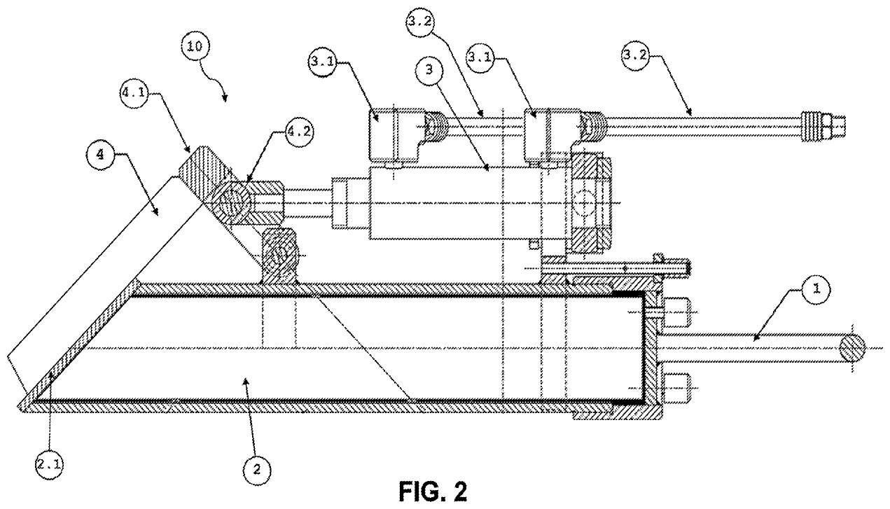

FIG. 2 represents a sectional view of the device for collecting marine sediments using a remotely operated vehicle (ROV) 10, according to a preferred embodiment of the present invention, which illustrates the cover 4 completely closing the chamfered opening 2.1 of the central body 2.

In addition, FIG. 2 presents at least one joining means 3.1 with cabling from the ROV drive system 3.2 connected to the same.

According to a preferred embodiment of the present invention, the device for collecting marine sediments using a remotely operated vehicle (ROV) 10 is submerged from the marine surface to the ocean floor, coupled to the ROV or through cables, moorings, or chains that are connected in handle 1.

In sequence, the device for collecting marine sediments using a remotely operated vehicle (ROV) 10 is spiked into the ocean floor, wherein the spiking into the ocean floor is carried out through the chamfered opening 2.1 at the lower end of the body 2.

Immediately after the device for collecting marine sediments using a remotely operated vehicle (ROV) 10 is spiked into the ocean floor through the chamfered opening 2.1, the cover 4 is driven to the closing position of the chamfered opening 2.1. Specifically, the cover 4 is attached to the lower end of the central body 2 through a hingeable structure 4.1, which comprises at least one connection means 4.2 for connection with the drive mechanism 3, wherein the drive mechanism 3 is connected to a ROV drive system 3.2, through at least one joining means 3.1.

Specifically, the cover 4 is movable between a position parallel to the central body 2 and a closing position of the opening 2.1, and this movement takes place through the driving carried out by at least one drive mechanism 3, which is connected to at least one connection means 4.2 of the hingeable structure 4.1 of the cover 4, as well as to a ROV drive system 3.2, through the at least one joining means 3.1.

The drive mechanism 3 is preferably at least one hydraulic cylinder or at least one pneumatic cylinder. The ROV 3.2 drive system is preferably a hydraulic system or a pneumatic system. The joining means 3.1 can be any joining means that interconnects the drive mechanism 3 with a compatible ROV drive system 3.2, such as, for example, an elbow.

After closing the chamfered opening 2.1 at the lower end of the central body 2 with the cover 4, the device for collecting marine sediments using a remotely operated vehicle (ROV) 10 is hoisted from the ocean floor to the sea surface and, subsequently taken to the support vessel, coupled to the ROV or through cables, moorings, or chains connected to handle 1.

Therefore, the immediate closing of the chamfered opening 2.1 at the lower end of the central body 2 by the cover 4, immediately after spiking the device for collecting marine sediments using a remotely operated vehicle (ROV) 10 on the ocean floor, ensures that sediments consolidated or poorly consolidated marine assets are not lost when hoisting the device for collecting marine sediments, using a remotely operated vehicle (ROV) 10, from the ocean floor to the support vessel.

Those skilled in the art will value the knowledge presented here and will be able to reproduce the invention in the presented embodiments and in other variants, covered in the scope of the appended claims.

1. A device for collecting marine sediments using a remotely operated vehicle (ROV), comprising:
at least one handle;
at least one central body;
at least one drive mechanism; and
at least one cover;
wherein the at least one central body includes a lower end comprising an opening;
wherein the drive mechanism comprises at least one joining means for connection to an ROV drive system; and
wherein the at least one cover comprises at least one hingeable structure having at least one connection means for connecting to at least one drive mechanism.

2. The device of claim 1, wherein the at least one handle is attached to the upper part of the central body.

3. The device of claim 1 wherein the at least one handle has a “T” shape, and comprises one or more vertical rods attached to the central body.

4. The device of claim 1, wherein the at least one central body is tubular, parallelepiped, or cylindrical.

5. The device of claim 1, wherein the at least one central body comprises an internal space for storing the marine sediments.

6. The device of claim 1, wherein the opening at the lower end of the central body is chamfered.

7. The device of claim 1, wherein the at least one drive mechanism is attached to the upper part of the central body.

8. The device of claim 1, wherein the at least one drive mechanism comprises at least one hydraulic cylinder or at least one pneumatic cylinder.

9. The device of claim 1, wherein the ROV drive system comprises a hydraulic system or a pneumatic system.

10. The device of claim 1, wherein the cover is attached to the central body through the at least one hingeable structure.

11. The device of claim 1, wherein the cover is movable between a position parallel to the body center and a closed position adjacent the opening at the lower end of the central body.
